(19) United States
(12) Patent Application Publication
(10) Pub. No.: US 2022/0194001 A1
(43) Pub. Date: Jun. 23, 2022

(54) Calibration of tight spot energy solid-state emitters

(71) Applicant: Hewlett-Packard Development Company, L.P., Spring, TX (US)

(72) Inventors: Esteve Comas Cespedes, Sant Cugat del Valles (ES); Xavier Soler Pedemonte, Sant Cugat del Valles (ES); Jordi Blanch Costa, Sant Cugat del Valles (ES)

(73) Assignee: Hewlett-Packard Development Company, L.P., Spring, TX (US)

(21) Appl. No.: 17/416,125

(22) PCT Filed: Sep. 10, 2019
(86) PCT No.: PCT/US2019/050423

§ 371 Date: Jun. 18, 2021

(51) Int. Cl. B29C 64/268; B29C 64/393

(52) U.S. Cl. CPC B29C 64/268; B33Y 10/00; B29C 64/393

(57) ABSTRACT

A printing unit comprises a movable carriage being movable along a path and having a plurality of energy emitters arranged in an array, a controller to control a supplied energy level of the emitters, and a sensor unit to measure an emitted energy level of each emitter, wherein the controller is to compare the measured energy level with a target energy level associated with the supplied energy level to obtain and to generate a matrix indicating a compensation value for each emitter based on the comparison result so as to calibrate the energy level of comparison result.

### BACKGROUND

3D print systems are used to generate objects by forming a layer of a build material such as plastic or metal powder on a print area (or print zone). Some 3D print systems comprise a movable carriage which is movable along with a path and having a plurality of emitters. 3D objects may be generated, layer-by-layer, by emitting energy from the plurality of emitters of the movable carriage to each layer of build material to cause one or more of heating, coalescence, fusing, sintering, melting, and curing. The energy level of the emitter is controlled for generating target emitting energy to the build material.

### BRIEF DESCRIPTION OF THE DRAWINGS

Examples will now be described with reference to the accompanying drawings, in which:

FIGS. 1A and 1B are a schematic view of a printing unit according to an example of the present disclosure;

FIGS. 2A and 2B are simplified schematic view of the printing unit according to another example of the present disclosure;

FIG. 3 is a schematic illustration of the emitters and the sensors according to an example of the present disclosure;

FIG. 4 is a schematic illustration of the emitters and the sensors according to another example of the present disclosure;

FIGS. 5A and 5B are schematic illustrations of the emitters and the sensors according to further example of the present disclosure;

FIG. 6 illustrates a schematic view of an emitter-sensor arrangement according to an example of the present disclosure;

FIG. 7 shows a schematic illustration of an emitter's position according to an example of the present disclosure;

FIG. 8 shows a schematic illustration of a protector to protect the sensor unit according to an example of the present disclosure;

FIGS. 9A to 9E show schematic illustrations to indicate alignment of the emitters to the sensors according to examples of the present disclosure;

FIGS. 10A and 10B show schematic illustrations to indicate alignment of the emitters to the sensors according to other examples of the present disclosure;

FIGS. 11A to 11E show schematic illustrations to change a target value of the emitters according to an example of the present disclosure;

FIGS. 12A to 12D illustrate compensation of the measured energy value according to examples of the present disclosure;

FIG. 13 shows an example of a compensation matrix according to the present disclosure;

FIGS. 14A to 14F illustrate a measurements process of emitters according to examples of the present disclosure;

FIG. 15 shows another example of a compensation matrix according to the present disclosure;

FIGS. 16A and 16B show compensating a total value of an emitter group according to examples of the present disclosure;

FIG. 17 is a flowchart indicating a method for calibrating an energy level of each emitter according to an example of the present disclosure;

FIG. 18 is a flowchart indicating a method for sensor calibration according to an example of the present disclosure;

FIG. 19 shows a schematic illustration of a 3D printing system according to an example of the present disclosure; and

FIG. 20 shows an illustration of a process of sensor calibration according to another example of the present disclosure.

### DETAILED DESCRIPTION

In the following detailed description, reference is made to the accompanying drawings. The examples in the description and drawings are to be considered illustrative and are not intended as limiting to the specific example or element described. Multiple examples may be derived from the following description and drawings through modification, combination of variation or certain elements.

The printing process starts spreading build material, for example, plastic or metal powder on the surface of a print area unit, e.g., a print bed or print platform, having the print zone covered by the build material. Then, for example, a fusing agent is jetted at target locations on the build material to define the geometry of the single or multiple parts that are to be printed. Then, an energy source helps fuse portions of the build material on which fusing agent was jetted, thereby forming a layer of the 3D part. This process is repeated until the part or parts are formed. The energy source may comprise, for example, LEDs, lasers, VCSEL arrays, etc. Such energy sources may be considered to be tight spot energy emitters. However, every emitter has a manufacturing tolerance and, therefore, it is useful to calibrate energy emitters to obtain energy emission uniformity.

Examples of the present disclosure relate to a printing unit and methods to perform tight spot emitter calibration. The emitter may perform differently in different environments. In addition, when using tight spot emitters, it is useful to calibrate the emitted energy level of each emitter. Furthermore, the emitters usually have a manufacturing tolerance and, therefore, it may be difficult to control the emitted energy level to obtain energy emission uniformity on the build material. For example, in case a plurality of emitters are arranged along the moving direction, it may be difficult to obtain energy emission uniformity. In other words, there is no guarantee that a plurality of emitters radiates the same emitted energy level even if the same amount of energy is applied to each emitter. Thus, examples of the present disclosure improve calibration accuracy and compensate an energy level of the emitters to obtain a target energy level.

Examples of the present disclosure aim to improve calibration accuracy and compensate an energy level of the emitters and, therefore, to improve the printing precision. Examples permit a calibration that may be run by a customer on each individual system.

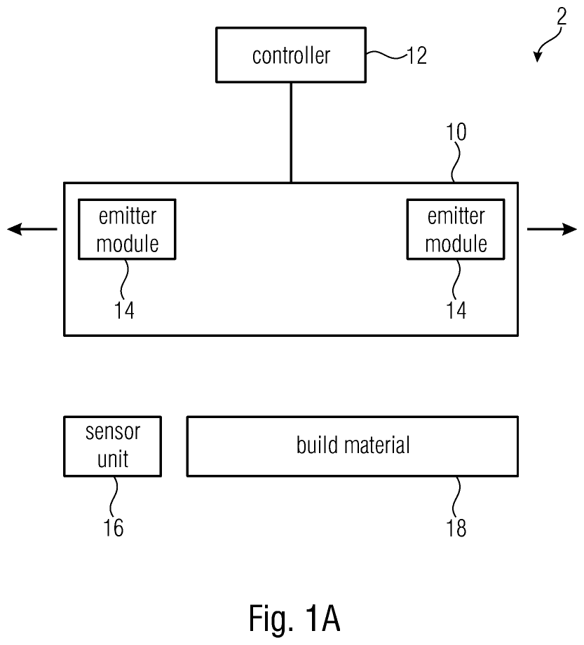

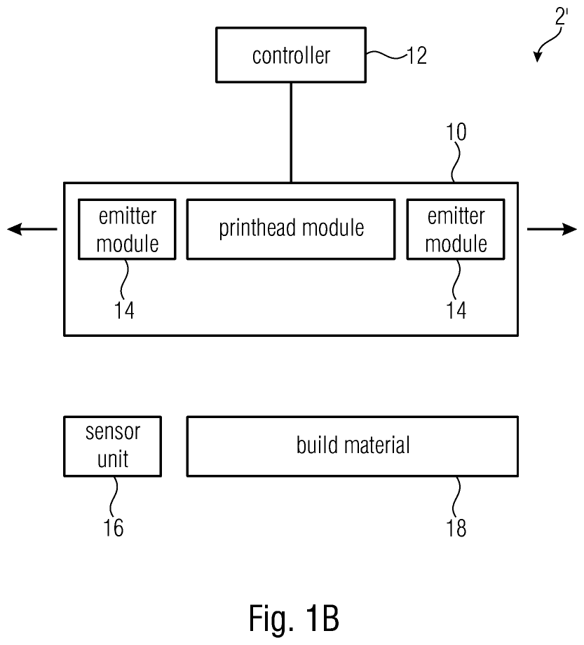

FIG. 1A illustrates a printing unit 2 according to an example of the present disclosure. The printing unit 2 comprises a movable carriage 10 having emitter modules 14, a controller 12 and sensor unit 16. The movable carriage 10 may include a printhead module and the emitter module 14 is assembled next to the printhead module. The emitter module 14 includes a plurality of energy emitters arranged in an array as explained below. In FIG. 1A, two emitter modules 14 are provided in the carriage 10, however, a number of the emitter module in the carriage may depend on a variety of conditions, e.g., target printing characteristics, size of the printing unit 2, running cost and the number of the emitter modules may be, for example, three, four or more. The carriage 10 is movable along with a path, e.g., right and left in the horizontal direction in FIG. 1A. The carriage 10 may be further movable front and back in the horizontal direction in FIG. 1A and also up and down in vertical direction in FIG. 1A. Furthermore, the carriage 10 may be rotatable along vertical axis with respect to the build material. The movement of the carriage 10 is controlled by the controller 12 which is connected, for example, via a connecting wire or a wireless connection to the carriage 10.

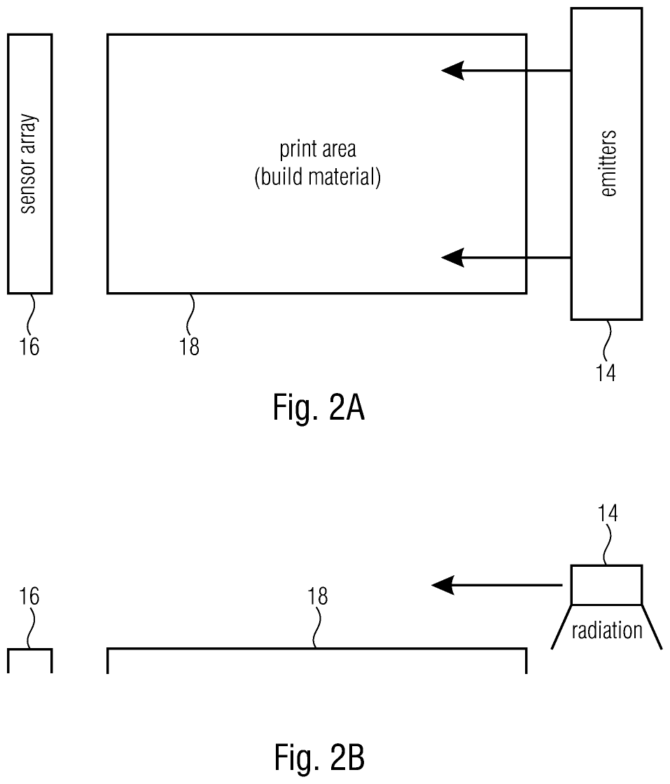

The controller 12 controls an energy level of each emitter of the emitter module 14, i.e., power level to be applied to each emitter is controlled by the controller 12. The sensor unit 16 measures an emitted energy value from each emitter of the emitter module 14 and the measured energy level, i.e., radiated/emitted energy level measured by the sensor unit 16, is transmitted to the controller 12 via the connecting wire or the wireless connection. The sensor unit 16 may be arranged next to the build material 18, i.e., a printing area, a print zone, a print bed or print platform where the build material 18 may be placed and may be emitted by the emitter module 14. The sensor unit 16 may be positioned in the path of the carriage 10 as shown in FIG. 2A. That is, the carriage 10 or emitter module/emitters 14 moves for printing in a direction indicated by arrows in FIG. 2A, e.g., left and right in a horizontal direction indicated in FIG. 2B, to radiate an energy to the build material 18, and therefore, the sensor unit 16 may be also radiated by the emitter module 14 as shown in FIG. 2B. In case the carriage 10 is movable for printing front and back in a horizontal direction in FIG. 2A, the position of the sensor unit 16 is changed to be positioned in the path of the carriage 10. When the emitter is a light source such as LED, Laser, VCSEL and etc., an optical sensor is used as the sensor provided in the sensor unit 16. It is noted that the directions such as left and right or front and back are used as example and do not limit the scope of the disclosure.

FIG. 1B shows another example of a printing unit 2′ according to the present disclosure. As shown in FIG. 1B, the printing unit 2′ is different from the printing unit 2 in FIG. 1A that the carriage 10 further includes a printhead/printhead module. The printhead may be included in a separate/independent carriage which is also controlled by the controller 12.

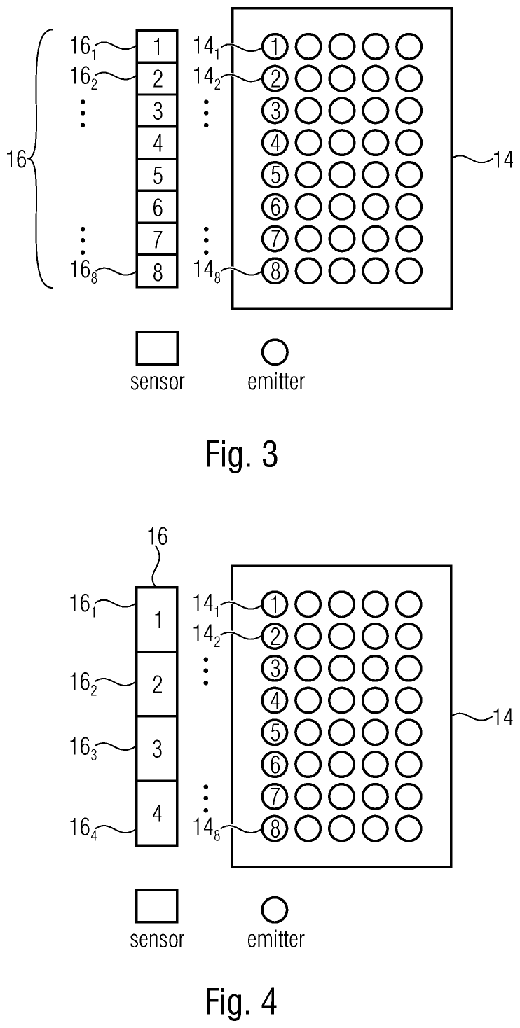

FIG. 3 shows an example of emitter arrangement in the emitter module 14. As shown in FIG. 3, the emitter module 14 comprises a plurality of emitters arranged in an array, for example, in a matrix or a lattice or a set of quincunxes (see, for example, FIG. 7). The total number of emitters is dependent on several conditions such as the target characteristics of the printing unit or a size of the printing unit, etc., i.e., figures of the present disclosure indicate an example arrangement and numbers of the emitters, and the arrangement and the numbers of the emitters are not limited as depicted in figures. For example, FIG. 3 shows a matrix having five columns and eight rows, however, the number of columns and the number of rows, or the number of emitters included in a column or row are not limited as depicted in figures of the present disclosure. The sensor unit 16 comprises a plurality of sensors which is arranged in a column as shown in FIG. 3. In FIG. 3, a number of the emitters in a single column of the matrix and a number of the sensors arranged in the column is the same, i.e., eight emitters 14₁ to 14₈ are arranged in the first column of the emitter module 14 and eight sensors 16₁ to 16₈ are arranged in the column of the sensor unit 16. That is, the number of the sensors corresponds to the number of the emitters in the single column. In this case, each sensor is able to measure the emitted energy level from each emitter at the same time. However, the number of the sensors and the number of the emitters in the column may be different and varied as explained below.

As shown in FIG. 4, the number of sensors may be different from the number of the emitters in the single column. That is, a sensor 16₁ may be associated with emitters 14₁ and 14₂, a sensor 16₂ may be associated with emitters 14₃ and 14₄, a sensor 16₃ may be associated with emitters 14₅ and 14₆, and a sensor 16₄ may be associated with emitters 14₇ and 14₈. An associated sensor may be used to measure the emitted energy level of an emitter. For example, the emitted energy level of the emitters 14₁, 14₃, 14₅ and 14₇ is measured by the sensors 16₁ to 16₄ at once, and the emitted energy level of the emitters 14₂, 14₄, 14₆ and 14₈ is measured by the sensors 16₁ to 16₄ at once. Measurements with the sensors 16₁, 16₂, 16₃ and 16₄ may also be performed sequentially. In other words, the emitted energy level of the emitter 14₁ and 14₂ may be measured by the sensor 16₁ during different time intervals. That is, one sensor may be associated with two emitters or different number of emitters, and therefore, each sensor may be used for measurement of the radiated energy from one single emitter.

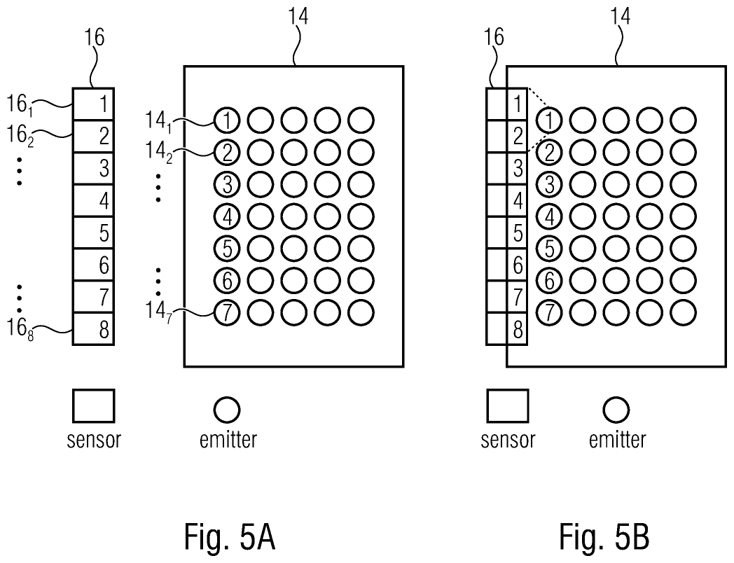

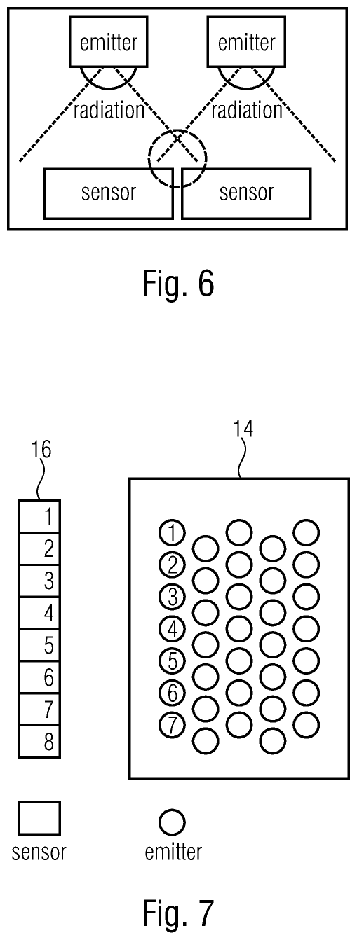

FIG. 5 shows another example of sensor-emitter arrangement according to the present disclosure. As shown in FIG. 5A, the number of the sensors in the sensor column may be more than the number of emitters in the single column arranged in the matrix, i.e., eight sensors arranged in the sensor column and the seven emitters arranged in the emitter column. When two sensors are arranged in a radiation coverage area or emitting area of a single emitter, e.g., the emitter 14₁ radiates the sensors 16₁ and 16₂, the emitted energy level of the emitter 14₁ may be measured by the sensors 16₁ and 16₂ as shown in FIG. 5B as indicated by a dashed-line. Also, the emitted energy level of the emitter 14₂ may be measured by the sensors 16₂ and 16₃. To allow unambiguous measurement results, measurements of the emitters 14₁ to 14₇ may be performed such that at a same time or during a single measurement capture, a sensor is irradiated or illuminated by a single emitter which may be obtained by parallel measurements in a configuration of FIG. 4 where a number of sensors associates with a number of emitters in an emitter column. In a configuration with a lower number of sensors, measurements may be executed sequentially. For example, the emitted energy level of emitters 14₁, 14₃, 14₅ and 14₇ is measured by the sensors 16₁ to 16₈ at the same time, and emitters 14₂, 14₄ and 14₆ is measured by the sensors 16₁ to 16₈ at the same time. Because the radiation coverage of the emitters 14₁ and 14₂ is overlapped, and therefore, the emitted energy level from the emitter 14₁ and 14₂ is not measured at the same time. That is, as shown in FIG. 6, i.e., when two neighbouring emitters are measured by two neighbouring sensors at the same time, there is an overlapping radiated area as indicated by a circle. The overlapping area may affect the measurement result and therefore, in this case, the measurements may be executed sequentially.

FIG. 7 shows a further variation of a sensor-emitter arrangement according to the present disclosure. The emitters are arranged in a lattice or a set of quincunxes. The emitted energy level from the emitters is measured in the same way as explained referenced to FIG. 3 or FIG. 5 dependent on the radiation coverage area of the emitters. In FIG. 7, each column has the same number of emitters, however, the number of the emitters in the column may be different. For example, a first, a third and a fifth column has seven emitters and a second and fourth column has six emitters or eight emitters. The number of columns and rows of the matrix is not limited as shown in the figures.

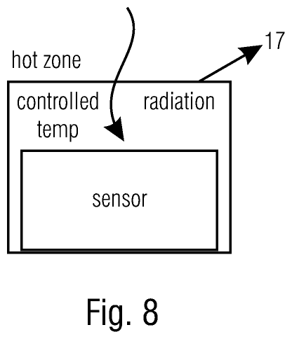

The sensor unit 16 or at least sensors of the sensor unit 16 are protected by a protector 17 to protect the sensors from dirtiness and heat caused by the radiation of the emitter, for example, as indicated in FIG. 8. The element used for the protector 17 is a transparent element for a radiation of the plurality of emitters. In other words, the protector 17 may let the energy emitted by the emitters or a predetermined wavelength of emitted light to pass through. As the element of the protector such as Borosilicate, Quartz, a filter or any material to protect and transparent may be used.

In the following, a detailed explanation for generating a matrix indicating a compensation value for each emitter is disclosed.

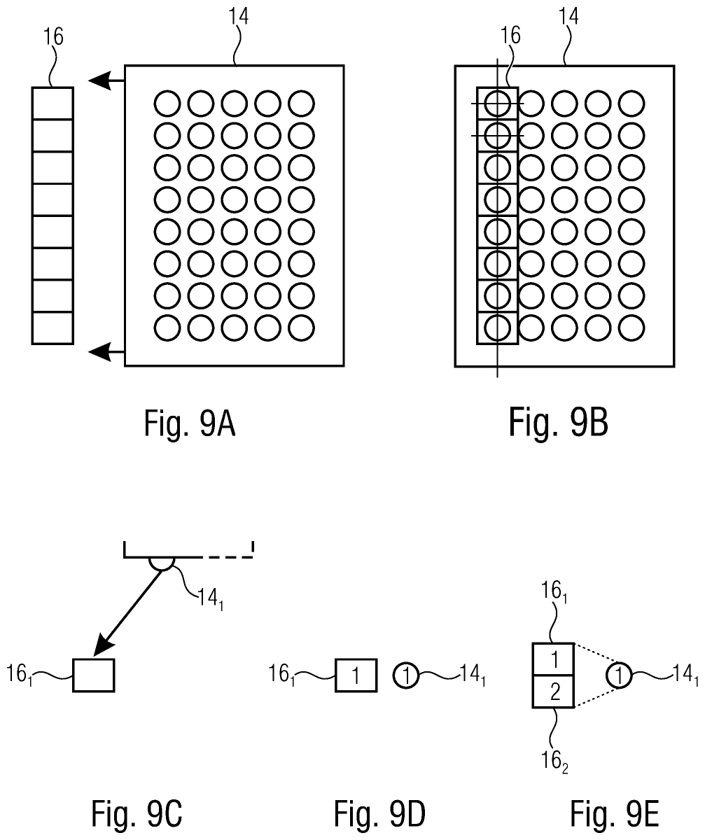

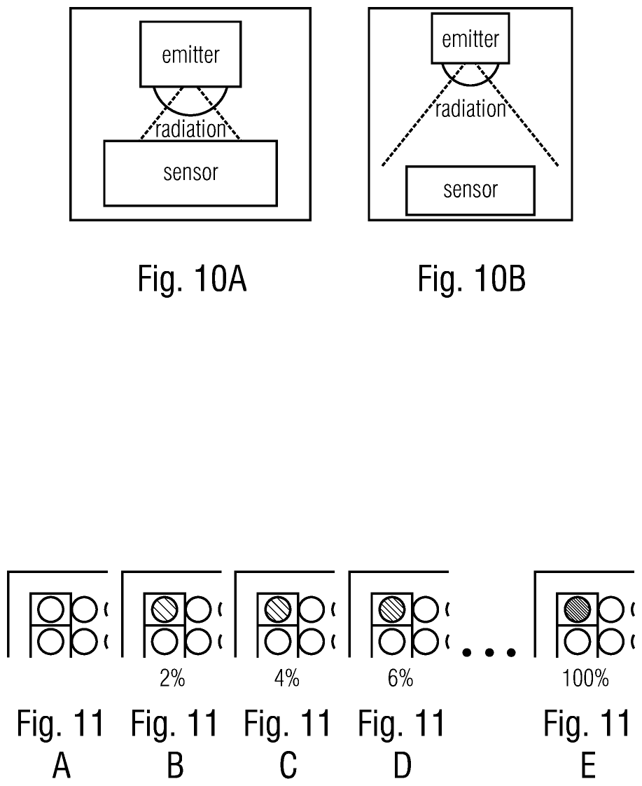

FIG. 9 depicts alignment between the sensors and the emitters. The alignment between the sensors and the emitters is controlled by the controller 12 by moving the carriage 10 for adjusting the position of the emitter module 14 to the sensor unit 16. The emitter module 14 is moved to the sensor unit 16 (see FIG. 9A) and accurately aligned each emitter in a first column of the matrix in a moving direction of the carriage 10 to each sensor arranged in the column by adjusting the position of the emitter module 14 (see FIG. 9B). For the alignment, the emitter module 14 is positioned that all direct radiation emitted by the emitters or a representative part of it falls on the sensing area of the associating/aligned sensor. That is, in case the direction of the direct radiation from the emitter is not vertical with respect to, for example, slightly tilted to the sensor as shown in FIG. 9C, then the emitter module 14 is aligned as shown in FIG. 5B. Then, for example, the emitted energy level from the sensor 14₁ may be measured by the sensor 16₁ as shown in FIG. 9D. In addition, when the emitting direction is tilted and a plurality of sensors may be included in the emitting area of the emitter, e.g., the sensors 16₁ and 16₂ may be included in the emitting area of the emitter 14₁ as indicated by a dashed-line in FIG. 9E, the emitted energy level of the emitter 14₁ may be measured by the sensors 16₁ and 16₂ as depicted in FIG. 9E. Furthermore, in case of having a dispersed emitting area, the emitters are aligned to the sensors considering the dispersion. The case that the direct radiation falls between sensors or an empty area is avoided. That is, the emitter and the sensor or sensors are aligned that all direct radiation emitted by the emitter or emitters, or a representative part of emitted energy falls on the effective sensing area of the sensor, for example, as shown in FIGS. 10A and 10B. In addition, the sensor unit 16 is positioned or placed in the same plane of the printing area where a build material is placed, e.g., print bed or print platform, and a distance between the carriage 10 and the sensor unit 16 is the same as a distance between the carriage and the printing area or adjacent hereto.

When the emitters of the first column are aligned to the sensors (see FIG. 11A), the controller 12 controls an energy level of each emitter of the first column. The supplied energy level of each emitter, i.e., the controlled energy level, is gradually changed, for example, 0% to 100% with resolution 2% as shown in FIGS. 11A to 11E. This gradually changed level may be every 5%, 8%, 10%, 12%, 15% or more and determined depending on the demanded accuracy of an energy level calibration. The sensor measures the emitted energy level of the emitter, i.e., the target energy level, so as to determine as the measured emitted energy level. Then, the measured energy level is transmitted from the sensor unit 16 to the controller 12.

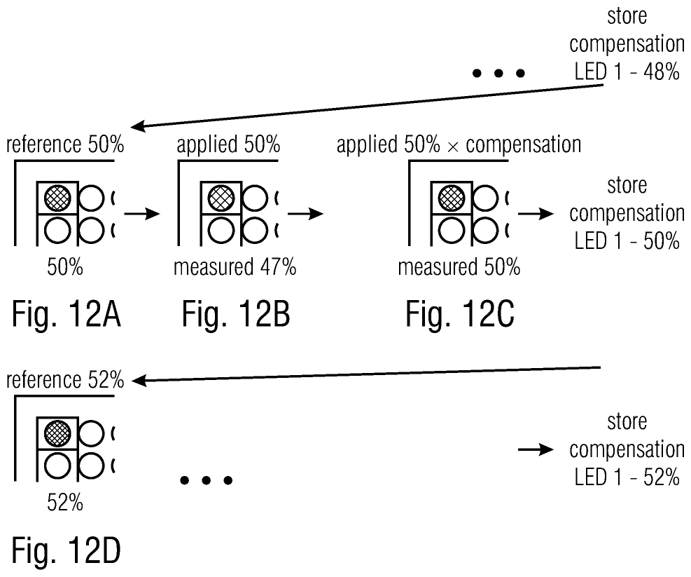

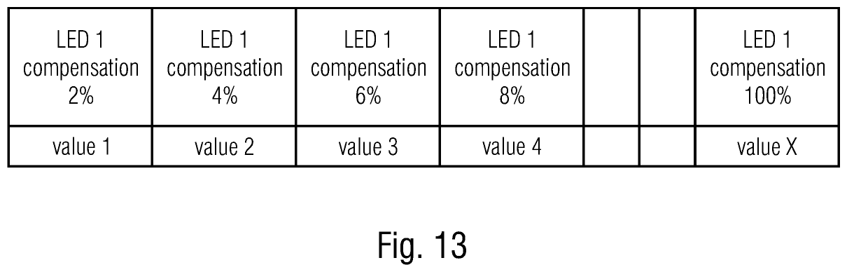

The controller 12 compares the measured energy level with a target energy level, e.g., a predetermined desired energy level, associated with the controlled energy level to obtain and generate a measure for a calibration between the desired target energy level and the measured energy level, e.g., a matrix indicating a compensation value for each emitter based on the comparison result so as to calibrate the energy level based on the comparison result. For example, in case the target energy level is 50% (see FIG. 12A), then the controlled energy level, reference, 50% is applied, however, the measured energy level is 47% (see FIG. 12B). Then, the controller 12 calculates a compensation value to obtain the measured energy value as 50% and may apply the compensated controlled energy level to the emitter, e.g., to verify the correction. When the measured energy level indicates 50% (see FIG. 12C), then the calculated compensation value is stored into the data storage, e.g., as a compensation matrix. In case the target energy level is 52%, the controlled energy level is 52% and the measured energy level is also 52% (see FIG. 12D), then, the compensation value for the target energy level 52% may be registered as brank or 1, i.e., any reference indicating no compensation value. From those values, the compensation matrix as shown in FIG. 13 may be generated by the controller 12 and stored in the data storage of the controller 12.

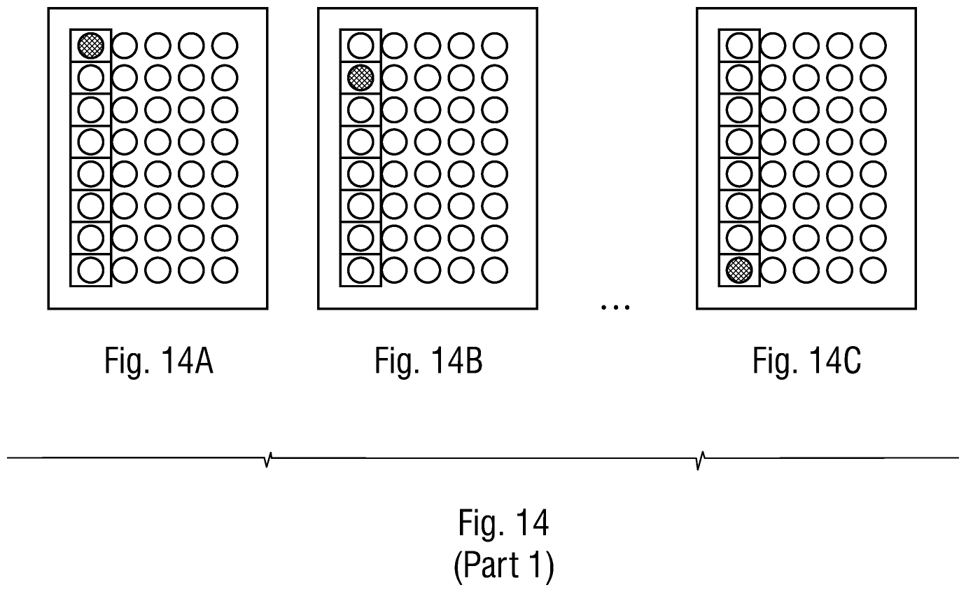

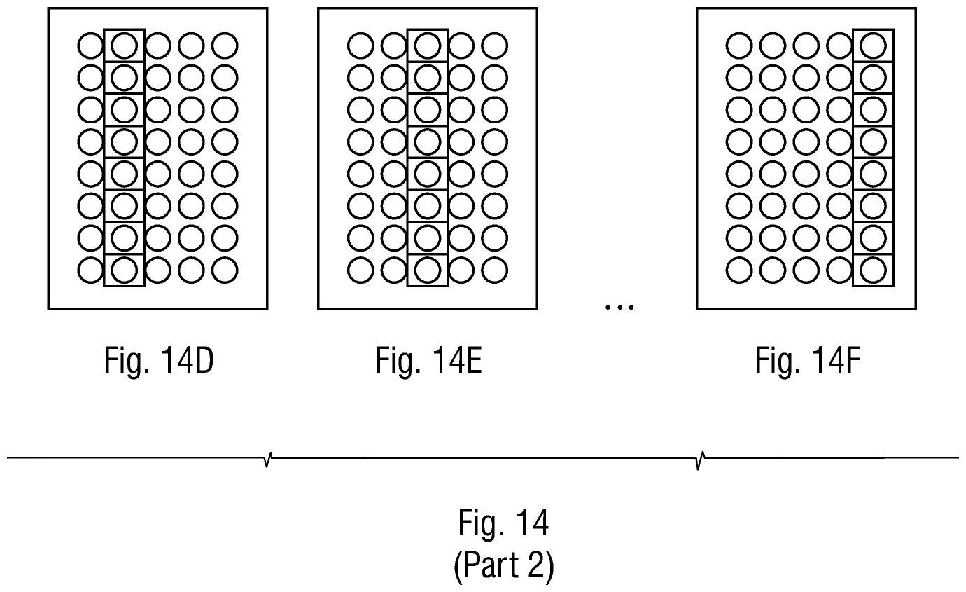

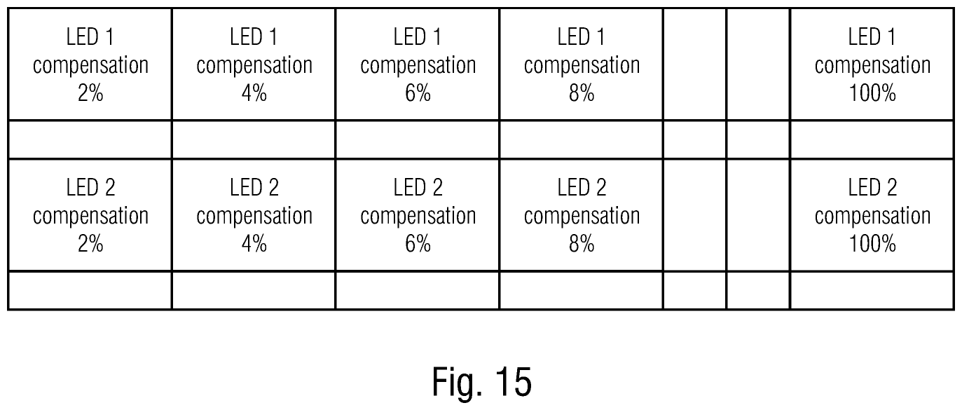

The compensation matrix may be generated for each emitter of the first column as shown in FIGS. 14A to 14C and FIG. 15. As already mentioned above, the emitted energy level of each emitter of the first column or a group of emitters in the first column may be measured at the same time and the compensation matrix for each emitter of the first column or the group of emitters in the first column may be generated at the same time. When the compensation matrix for each emitter of the first column is generated, then, the controller 12 may move the carriage 10 for aligning the emitters of a second column to the sensors (see FIG. 14D), e.g., the next or subsequent column. In the same manner, the compensation matrix for the remaining emitters may be generated (see FIGS. 14E and 14F).

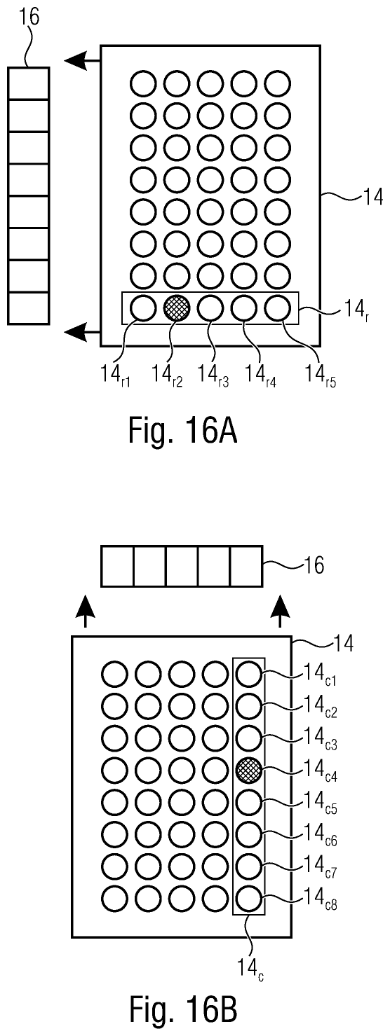

The controller 12 calibrates the controlled energy level so as to compensate for deviations between the target energy level and the measured energy level. As shown in FIG. 15, the compensation matrix is generated for each emitter of the emitter module 14, and hence, the calibration is done emitter by emitter or by group, i.e., column or row. That is, the emitters are arranged in the matrix having a plurality of rows and a plurality of columns, therefore, the controller 12 may calibrate a total value of a column or a row, e.g., a sum of the emitted energy level of a row or a column of the emitters in a moving direction of the carriage 10. For example, in addition or as another example to use calibration values for a same emitter as described, the emitted energy level of the emitter 14ᵣ₂ in row 14ᵣ in FIG. 16A is clearly below the target energy level, then, the emitted energy level of the emitter 14ᵣ₂ may be compensated by the emitters 14ᵣ₁ and 14ᵣ₃ by changing the controlled energy level to the emitters 14ᵣ₁ and 14ᵣ₃ to have the same total value as the emitter 14ᵣ₂ appropriately works. When the printing direction is different from as indicated in FIG. 16A, for example, as indicated in FIG. 16B, e.g., up and down direction in FIG. 16B, the total value of a column may be controlled. For example, the emitted energy level of the emitter 14ᵣ₄ in column 14_{c} is not enough, or not appropriate, then, the controlled energy level to the emitters 14_{c3} and 14_{c5} are improved to compensate the emitted energy level of the emitter 14_{c4}. In addition, when any one of the emitters is not compensable, e.g., an emitter is defective, the controller 12 is to generate a signal indicating a warning. When it is possible to identify the defective emitter, any form of the warning is used, e.g., a sound, message or light. The controller 12 may control the emitters of a row or column so as to compensate for a deviating or defective emitters in a way that, within a tolerance range of, e.g., 5%, 3%, 2% or 1% an emitted energy level between rows or columns is equal, that is, that an energy of a row or column remains constant and that multiple columns, rows respectively emit the same energy level. The tolerance range of an emitted energy level between rows or columns may be determined based on target conditions to the printing unit 2, e.g., target printing quality or characteristics of the build material.

As explained above, in examples, the controller 12 stores or records the compensation matrix for obtaining the target energy level on the build material. In such examples, the controlled energy level is changed differently, e.g., from a range 0% to 40% with resolution 8%, from 40% to 60% with resolution 5%, from 60% to 80% with resolution 2% and from 80% to 100% with resolution 5%. The range and the resolution may be defined dependent on the demanded accuracy of the printed object or customer demands.

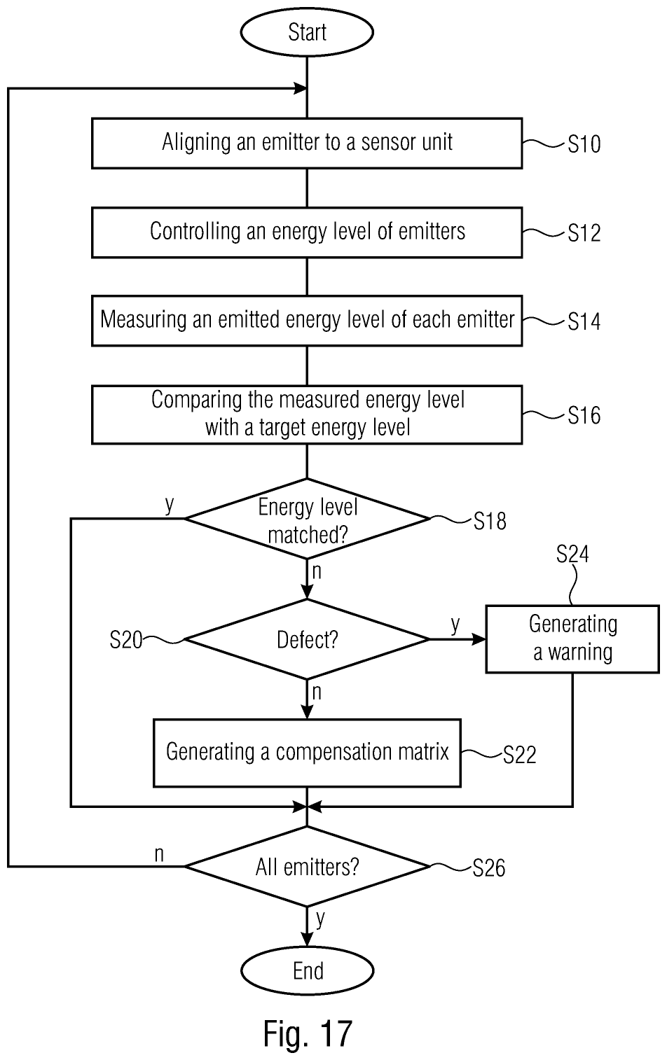

FIG. 17 shows a flowchart for explaining a method according to an example of the present disclosure, i.e., the flowchart may explain the emitter calibration process. The controller 12 may align the emitter and the sensor by moving the carriage 10 (S10). That is, the emitter is aligned and centered with the sensor as shown in FIG. 9B. Then, the controller 12 may control a controlled energy level of the emitters, e.g., the controller 12 may apply different amount of power, a controlled energy level, on each emitter (S12). For example, 2% of the total amount of power, and this can be from 0 to 100% with resolution of 2% or 5% or etc. Each sensor may measure the emitted energy level emitted by the emitter, i.e., the radiated energy level from the emitter (S14). The measured energy level may be transmitted from the sensor unit 16 to the controller 12 and stored to a data storage of the controller 12. The controller 12 may compare the measured energy level with a target energy level, i.e., an energy level to be radiated from the emitter, associated with the controlled energy level to be obtained (S16). For example, the controlled energy level is 2%, then, the target energy level is also 2% and the measured energy level is expected to be 2%. When the controlled energy level matches to the measured energy level (S18), no compensation value is obtained, and therefore, the controller 12 may identify whether the emitted energy level of all emitters in the emitter module 14 is measured (S26). When the emitted energy level of all emitters is already measured, then the process is terminated. Otherwise, the process is repeated for remaining emitters.

When the measured energy level does not match to the target energy level (S18), the controller 12 may identify whether the emitter is defective or not (S20). For example, the measured energy level is 3% and the target energy level is 2%, it is possible to compensate or adjust the measured energy level to determine the compensation value to obtain the measured energy level as 2%. Therefore, the controller 12 may identify that this emitter is not defective and generates a compensation matrix based on the comparison result (S22). That is, the controller 12 may calculate the compensation value based on the comparison result, e.g., a coefficient for calculating an appropriate power amount to be applied to the emitter to obtain a desired measured energy level. The generated compensation matrix may be stored to the data storage of the controller 12 and used for calibration of the emitter.

When the emitter does not radiate any energy even some power amount is applied, the controller 12 may identify that this emitter is defective (S20). For example, in case the difference between the measured energy level and the target energy level is larger than predetermined range, e.g., resolution 2% and difference is over or equal to 5%, the emitter is identified as defective. The range indicating the difference between the measured energy level and the target energy level may be determined based on the demanded accuracy of the calibration. When the emitter is defective or not working, the controller 12 may generate a signal indicating a warning (S24). Then, the controller 12 may identify whether the emitted energy level of all emitters in the emitter module 14 is measured (S26). When the emitted energy level of all emitters is already measured, then the process is terminated. Otherwise, the process is repeated for remaining emitters.

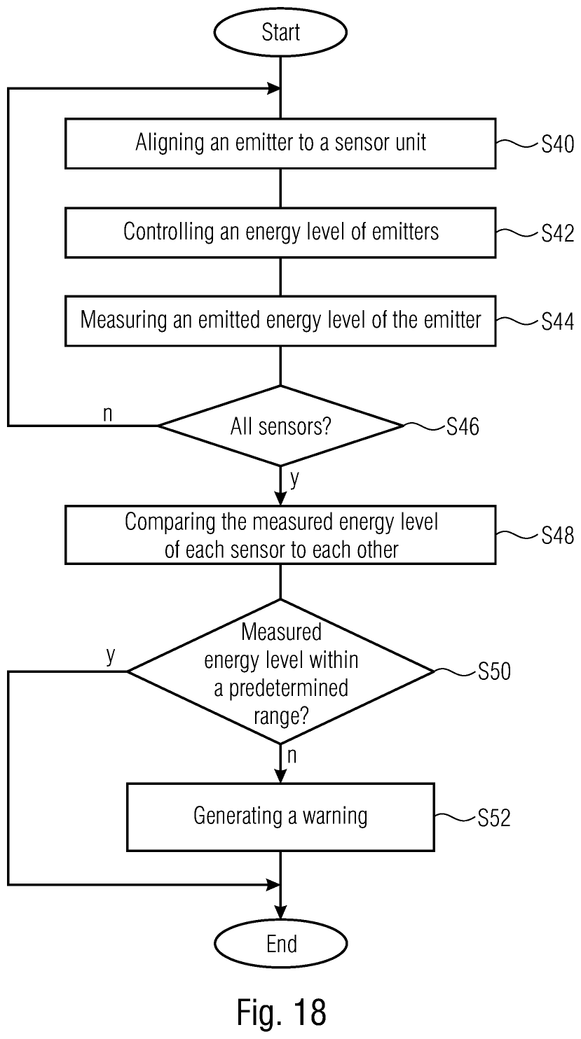

It was found that deviations may also between sensors such that a measurement may be of high accuracy when calibrating sensors. FIG. 18 shows a flowchart for a sensor calibration according to an example of the present disclosure. The controller 12 may align an emitter to a sensor unit 16, i.e., a sensor (S40). For example, the emitter 14₁ is aligned to the sensor 16₁ as shown in FIG. 3. Then, the controller 12 may control the power amount to be applied to the emitter 14₁ (S42). For example, 50% of the power amount, i.e., the controlled energy level, is applied to the emitter 14₁. Then, the sensor 16₁ may measure the emitted energy level from the emitter 14₁ (S44). The measured energy level may be transmitted from the sensor unit 16 to the controller 12 and stored into the data storage. When there are still sensors which do not measure the emitted energy level of the emitter 14₁ (S46), the controller 12 may align the emitter 14₁ to a further sensor, e.g., a sensor 16₂, and the process indicated by S40 to S44 may be repeated. That is, the emitted energy level from the emitter 14₁ is measured by each of sensors 14₁ to 14₈.

When all sensors measure the emitted energy level of the emitter 14₁ (S46), the controller 12 may compare the measured energy level(s) of each sensor to each other (S48). When each sensor has the same function or the same measuring capability, the measured energy level of each sensor is the same or within a predetermined range, for example, the difference or deviation between the measured energy level of the sensor 16₁ and the sensor 16₂ is within a predetermined range, i.e., the deviation in a tolerance of ±0.5% or ±1% or ±1.5%. That is, the sensor calibration process is operated to confirm that every sensor measures the same values within a predetermined or acceptable range of deviation considering the manufacturing tolerance. Hence, when the measured energy level is out of the predetermined range (S50), the controller 12 may generate a signal indicating a warning (S52). The predetermined range, i.e., the predetermined tolerance may be determined based on the target energy level control accuracy of the printing unit 2.

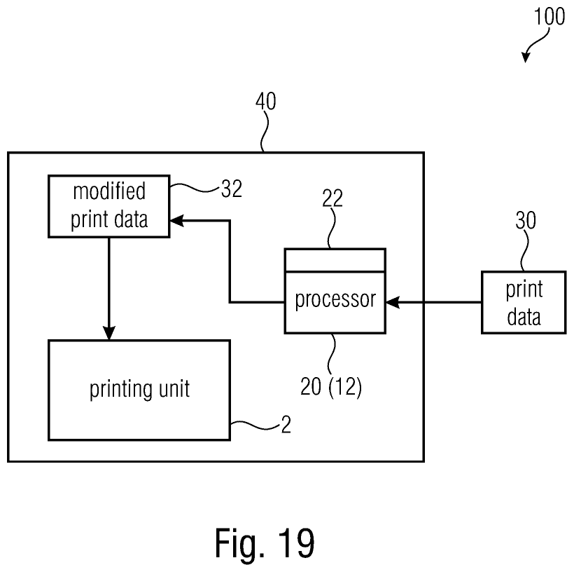

FIG. 19 shows a 3D print system 100 in accordance with the present disclosure comprises a 3D printing machine 40 comprising the printing unit 2 according to the present disclosure. The 3D printing machine executes a build process to print an object in a print chamber of the 3D printing machine using the printing unit 2. The emitter calibration process of the present disclosure may be performed when the printing unit 2 is assembled into the 3D printing machine for the first time, before starting a new operation or once the emitter module 14 has been replaced for a new one, or when as needed.

Print system 100 may include a processor 20 and machine readable medium 22. The processor 20 may work as the controller 12 of the printing unit. Machine-readable medium 22 may be encoded with instructions to perform the methods as described herein and to achieve the functionality described herein. Machine-readable medium 22 may also store print data describing an object to be printed, such as a 3D object, and/or modified print data describing a modified object to be printed. Processor 20 may be to execute instructions stored on machine-readable medium 22 to perform the methods described herein at least in part. Processor 20 may be implemented, for example, by one discrete module or a plurality of discrete modules, or data processing components, that are not limited to any particular hardware and machine-readable instructions configuration. Processor 20 may be implemented in any computing or data processing environment, including in digital electronic circuitry, e.g., an application-specific integrated circuit, such as a digital signal processor, DSP, or in computer hardware, device driver. In some implementations, the functionalities are combined into a single data processing component. In other implementations, the respective functionalities may be performed by a respective set of multiple data processing components. Machine-readable medium 22 may comprise a memory device or memory devices. The memory device or devices may include a tangible machine-readable storage medium or a plurality of tangible machine-readable storage media. Memory devices suitable for embodying these instructions and data include all forms of computer-readable memory, including, for example, semiconductor memory devices, such as EPROM, EEPROM, and flash memory devices, magnetic disks such as internal hard disks and removable hard disks, magneto-optical disks, and ROM/RAM devices.

Print data 30 defining an object to be printed may be received by printing system 100 and may be stored in machine-readable medium 22. Processor 20 may process or modify the received print data 30 to obtain modified print data 32. The modified print data 32 may be applied to the printing unit 2 in order to generate an object according to the modified print data 32.

In examples, print data 30 describe an original model representing an originally intended design to be produced as a printed object. For example, the original model may be a tangible model, or may be a virtual original model in the form of digital image data. In this disclosure, “virtual” may be interpreted as “digital”. For example, the original model may be presented through a display to allow an end user or operator to choose such original model for printing. In examples, the original model may be presented through a third party website or application. In examples, the original model includes three dimensional image data and/or may include a two-dimensional image or a collection of two dimensional images to construe a three dimensional object layer by layer. In examples, the original model is communicated to the print system 100 in the form of digital print data, for example in a file format suitable for processing, conversion and/or printing by the print system 100. In one example, the original model may be stored on a computer readable medium, that may be part of the print system 100. In other instances, the computer readable medium may be a mobile non-volatile memory or may be part of a distant computing device such as a server, a database, etc. In examples, the original model may be presented by and/or downloadable from such distant computing device, for example through a third party website or application.

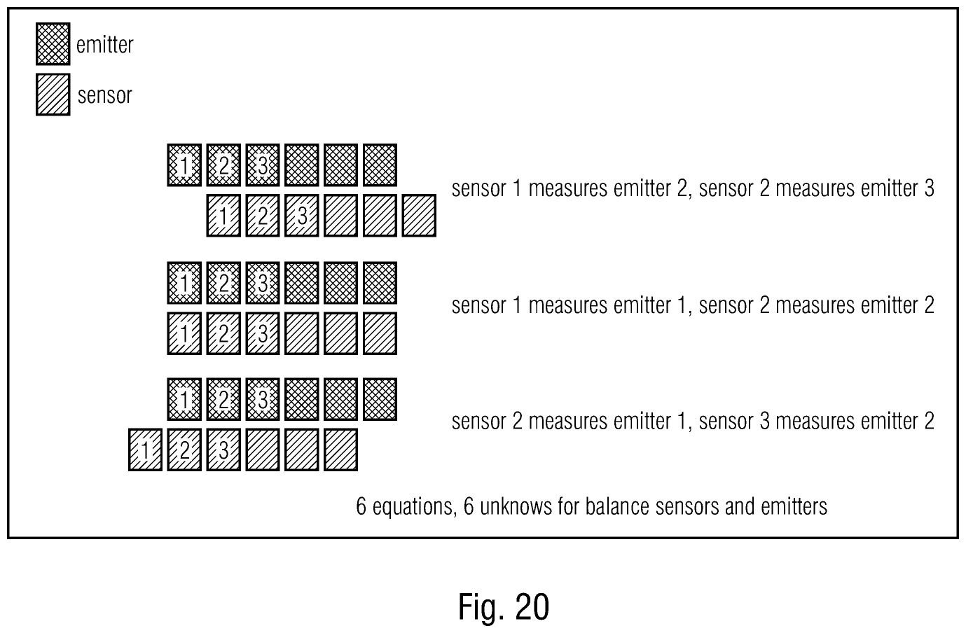

In addition, the sensor calibration process may be performed before assembling the printing unit 2 into the 3D printing machine. In case the printing unit 2 is already assembled into the 3D printing machine and the sensor unit 16 is changed, then, the sensor calibration process may be performed using an indexing process formulating X equations with Y unknown values for balancing the sensors and the emitters. FIG. 20 shows an illustration of performance of the sensor calibration according to an example of the present disclosure. As shown in FIG. 20, an emitted energy level from every six emitters is measured by each sensor and the controller 12 generates an index of the measured energy level to identify the defective sensor or the sensor out of the predetermined range, i.e., six equations and six unknowns for balancing the sensors and the emitters.

As explained above, in examples, every energy level to be applied to the emitter is precisely controlled by using the compensation matrix. Thus, examples of the present disclosure allow to calibrate the emitted energy level from the emitter to obtain the target energy level, i.e., the controlled energy level is well calibrated to obtain a homogeneous radiation on the build material and, hence, the printed part quality is improved.

In examples of the present disclosure, the distance between the sensor unit and the carriage, and the distance between the build material and the carriage is the same distance, e.g., the same distance in tolerance of several percent. Hence, the sensors are to measure the emitted energy level precisely.

Examples relate to a non-transitory machine-readable storage medium encoded with instructions executable by a processing resource of a computing device to perform methods described herein.

Examples described herein may be realized in the form of hardware, machine-readable instructions or a combination of hardware and machine-readable instructions. Any such machine-readable instructions may be stored in the form of volatile or non-volatile storage such as, for example, a storage device, such as a ROM, whether erasable or rewritable or not, or in the form of memory such as, for example, RAM, memory chips, device or integrated circuits or an optically or a magnetically readable medium, such as, for example, a CD, DVD, magnetic disk or a magnetic tape. The storage devices and storage media are examples of machine-readable storage, that are suitable for storing a program or programs that, when executed, implement examples described herein.

Although some aspects have been described as features in the context of an apparatus it is clear that such a description may also be regarded as a description of corresponding features of a method. Although some aspects have been described as features in the context of a method, it is clear that such a description may also be regarded as a description of corresponding features concerning the functionality of an apparatus.

In the foregoing Detailed Description, it may be seen that various features are grouped together in examples for the purpose of streamlining the disclosure. This method of disclosure is not to be interpreted as reflecting an intention that the claimed examples may comprise more features than are expressly recited in each claim. Rather, as the following claims reflect, inventive subject matter may lie in less than all features of a single disclosed example. Thus, the following claims are hereby incorporated into the Detailed Description, where each claim may stand on its own as a separate example. While each claim may stand on its own as a separate example, it is to be noted that, although a dependent claim may refer in the claims to a specific combination with another claim or other claims, other examples may also include a combination of the dependent claim with the subject-matter of each other dependent claim or a combination of each feature with other dependent or independent claims. Such combinations are proposed herein unless it is stated that a specific combination is not intended. Furthermore, it is intended to include also features of a claim to any other independent claim even if this claim is not directly made dependent to the independent claim.

The above-described examples are merely illustrative for the principles of the present disclosure. It is understood that modifications and variations of the arrangements and the details described herein will be apparent to others skilled in the art. It is the intent, therefore, to be limited by the scope of the pending patent claims and not by the specific details presented by way of description and explanation of the examples herein.

1. A printing unit comprising:
a carriage movable along a path and having a plurality of energy emitters arranged in an array;
a controller to control a supplied energy level of the emitters; and
a sensor unit to measure an emitted energy level of each emitter,
wherein the controller is to compare the measured energy level with a target energy level associated with the supplied energy level to obtain and to generate a matrix indicating a compensation value for each emitter based on the comparison result so as to calibrate the energy level of comparison result.

2. The printing unit according to claim 1, wherein the sensor unit includes a plurality of optical sensors, and
the sensor unit is positioned or positionable in the path of the carriage.

3. The printing unit according to claim 2, wherein each optical sensor is used for measurement of the radiated energy from one single emitter at a time.

4. The printing unit according to claim 1, wherein the controller is to change the energy level associated with a changed target energy level of the emitters using the compensation value.

5. The printing unit according to claim 1, wherein the controller is to calibrate the supplied energy level so as to compensate for deviations between the target energy level and the measured energy level, and
the controller is to generate a signal indicating a warning, when any one of the emitters is not compensable.

6. The printing unit according to claim 1, wherein the array includes a plurality of rows and a plurality of columns, and
wherein the controller is to calibrate a total value being a sum of the emitted energy level of each row or each column of the emitters in a moving direction of the carriage.

7. The printing unit according to claim 1, wherein the sensor unit comprises a protector to protect the sensor unit, the protector being transparent for a radiation of the plurality of emitters.

8. The printing unit according to claim 1, wherein the sensor unit is placed in the same plane of a printing area where a build material is placed and a distance between the carriage and the sensor unit is the same as a distance between the carriage and the printing area.

9. A 3D print system comprising:
a 3D printing machine comprising the printing unit according to claim 1,
wherein the 3D printing machine is to execute a build process to print an object in a print chamber of the 3D printing machine using the printing unit.

10. A method comprising:
aligning an emitter of a carriage being along a path and having a plurality of emitters arranged in an array to a sensor unit to measure an emitted energy level of each emitter;
controlling a supplied energy level of the emitters;
measuring an emitted energy level of each emitter;
comparing the measured emitted energy level with a target energy level associated with the supplied energy level to obtain; and
generating a matrix indicating a compensation value for each emitter based on the comparison result so as to calibrate the energy level of comparison result.

11. The method according to claim 10, wherein the method further comprises:
changing the energy level associated with a changed target energy level of the emitters.

12. The method according to claim 10, wherein the array includes a plurality of rows and a plurality of columns, and the method further comprises:
calibrating a total value being a sum of the emitted energy level of each row or each column of the emitters in a moving direction of the carriage.

13. The method according to claim 10, wherein the method further comprises:
generating a signal indicating a warning, when any one of the emitters is not compensable.

14. The method according to claim 10, wherein the method further comprises:
measuring the emitted energy level of the emitter by each sensor included in the sensor unit;
comparing the measured energy level of each sensor to each other; and
generating a signal indicating a warning, when any one of the sensors indicates the measured energy level which is out of a predetermined range.

15. A machine-readable medium, having a set of computer-readable instructions, when executed, cause a processor to
align an emitter of a movable carriage being movable along a path and having a plurality of emitters arranged in an array to a sensor unit placed in the path of the carriage;
control a supplied energy level of the emitters;
measure an emitted energy level of each emitter;
compare the measured energy level with a target energy level associated with the supplied energy level to obtain; and
generate a matrix indicating a compensation value for each emitter based on the comparison result so as to calibrate the energy level of comparison result.
